(19) United States
(12) Patent Application Publication
(10) Pub. No.: US 2025/0227339 A1
(43) Pub. Date: Jul. 10, 2025

(54) ADAPTIVE CONTENT DISTRIBUTION USING PRIVATE ENCODED AUDIO IDENTIFIERS

(71) Applicant: Google LLC, Mountain View, CA (US)

(72) Inventors: Shreedhar Madhavapeddi, Seattle, WA (US); Shreya Mathur, Carnation, WA (US)

(21) Appl. No.: 18/008,863

(22) PCT Filed: Sep. 30, 2022
(86) PCT No.: PCT/US2022/045320

§ 371 Date: Dec. 7, 2022

(51) Int. Cl. H04N 21/4722; H04N 21/2343; H04N 21/2389; H04N 21/258; H04N 21/45

(52) U.S. Cl. CPC H04N 21/4722; H04N 21/2343; H04N 21/23892; H04N 21/25841; H04N 21/4524

(57) ABSTRACT

Methods, systems, and apparatus, including medium-encoded computer program products, for adaptive content distribution using private encoded audio identifiers are described. The techniques can include receiving event data that indicates that a digital component with an audio signature was transmitted to a display device. The event data can also include a time at which the digital component was transmitted. A content request can be received from a different client device and can include data representative of a captured audio signature and the time at which the audio signature was captured. In response to determining that the content request is requesting content related to the digital component based at least on (i) a determination that the audio signature matches the audio signature of the digital component and (ii) a determination that the time are within a threshold duration, the content related to the digital component can be sent to the client device.

### TECHNICAL FIELD

This specification relates to data processing and audio encoding.

### BACKGROUND

Content distribution includes the delivery of content over a network to user devices, such as mobile phones and tablets. Delivered content can include multimedia files that contain audio signatures, which can be tones that are discreetly encoded in video content that is displayed to a user on a first device, such as a large screen television, and that are not perceptible, or are barely perceptible, to humans

### SUMMARY

This specification describes technologies relating to adaptive content distribution using encoded identifiers such as audio signatures. While audio signatures are largely imperceptible to humans, audio signatures can be detected by second devices, such as users' mobile phones, and the audio signature can be used to deliver supplemental content relevant both to the video stream and to the user, provided the user has decided to opt-in.

Particular embodiments of the subject matter described in this specification can be implemented so as to realize one or more of the following advantages. The techniques described in this document can be used to provide supplemental content to a user on a second device based on an audio signature embedded in video content displayed to the user on a first device. Further, because the audio signature is embedded in the video content, and is not associated with the user, user privacy can be maintained. For example, the supplemental content can be provided to the user's device based on the audio signature without any indication of the identity of the user. The preferences that users indicate in aggregate using their second devices can also be used to influence which content is displayed on a primary device. In addition, the techniques can be used to embed an audio signature that is not based on the audio in the video content, which allows the techniques to be used when the video is silent.

The amount of information that can be embedded in an audio signature that is played with a video can be limited without negatively affecting the quality of the video. Techniques described in this document for correlating information captured in an audio signature with information reported by a device that displayed the video with the audio signature enables less information to be encoded in the audio signatures, resulting in audio signature encoding capabilities without (or at least with less) impact on the video quality. This enables audio signatures to identify billions of unique video presentations per day without negatively affecting video quality. Encoding less data in audio signatures also allows client devices, which typically have very limited processing power compared to server computers, to quickly decode the signatures and also reduces the consumed bandwidth to send the decoded information and/or the signature to another device to request the supplemental content related to the video.

The techniques described in this document also enable the measurement of performance information that was not previously measurable. For example, when a user requests supplemental content related to a video using an audio signature embedded in the video, a system can measure performance metrics, such as click-through rates and conversions related to the video, and even videos played before or after the video using the correlation and extrapolation techniques described in this document

In general, one innovative aspect of the subject matter described in this specification can be embodied in methods including receiving, from a video stream distribution device, first event data that can indicate that a digital component that includes an audio signature was transmitted to a given display device. The event data can include an identifier encoded in the audio signature and a first time at which the digital component was transmitted to the given display device. A content request can be received from a client device different from the display device and can include second event data that includes data representative of a captured audio signature and a second time at which the captured audio signature was captured. It can be determined that the content request is requesting content related to the digital component based at least on (i) a determination that the audio signature matches the audio signature of the digital component and (ii) a determination that the second time is within a threshold duration of the first time. In response to determining that the content request is requesting content related to the digital component, the content related to the digital component can be sent to the client device for display by the client device. Other implementations of this aspect include corresponding apparatus, systems, and computer programs, configured to perform the aspects of the methods, encoded on computer storage devices.

These and other implementations can each optionally include one or more of the following features. The content related to the digital component can include a different version of the digital component formatted for display by the client device. The video stream distribution device can insert the audio signature into the digital component prior to inserting the digital component into a video stream sent from the video stream distribution device to the given display device. The digital component can include a video snippet and the video stream distribution device can insert the audio signature into the digital component such that the audio signature repeats multiple times while the video snippet is played by the display device. The data representative of the captured audio signature can include the audio signature or the identifier decoded from the captured audio signature. The first event data can include a first location data identifying a geographic location of the given display device and the second event data can include second location data identifying a geographic location of the client device. Based on a determination that the geographic location of the given display device is within a threshold distance of the geographic location of the client device, it can be determined that the content request is requesting content related to the digital component. The identifier can identify the digital component or a unique impression of the digital component. In response to determining that the content request is requesting content related to the digital component, content can be sent that relates to one or more first digital components displayed by the given display device prior to display of the digital component and/or one or more second digital components displayed by the given display device after display of the digital component. The one or more first digital components and the one or more second digital components can be identified based on the first event data and respective event data for the one or more first and second digital components. One or more performance metrics can be updated for the digital component in response to determining that the content request is requesting content related to the digital component. One or more performance metrics can be updated for one or more additional digital components displayed before or after the digital component in response to determining that the content request is requesting content related to the digital component.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of an environment for adaptive content distribution using audio signatures having encoded identifiers.

FIG. 2 is a flow diagram of an example process for adaptive content distribution using audio signatures having encoded identifiers.

FIG. 3 is a block diagram of an example computer system.

Like reference numbers and designations in the various drawings indicate like elements.

### DETAILED DESCRIPTION

It is common for users to encounter content displayed on a large screen, such as a high-definition television, while also carrying a personal device such as a tablet or a cell phone, and in some cases, both a tablet and a cell phone. The content can vary widely from news to scripted programs to live sporting events, and so on.

In some cases, upon encountering such displayed content, a user might desire supplemental content related to the displayed content. For example, a user might want to learn about the driving range of an electric car displayed on the large screen or the career statistics of a player participating in a sporting event. However, to avoid requiring a user to perform a manual search, such situations require coordination among devices, including cases where the large screen is not controlled by the user, such as in a restaurant, hotel or airport. Thus, a need exists for a coupling between the large screen and the mobile device.

Further, when the user requests the supplemental content from a content distribution system, the digital content distribution system must have awareness of the displayed content. Therefore, the video stream distribution device that provides the displayed content must be coupled to the content distribution engine that provides appropriate supplemental information.

This specification describes techniques in which an audio signature is discretely embedded in video content. While a signature can be based on audio included in the video content (e.g., by applying a hash function to an encoding of the audio), some video does not have unique audio, or even audio at all. Therefore, the techniques can include embedding an audio signature that is not based on the video itself, as described further below.

The video content with the audio signature can be provided from a content distribution engine to a display device, which can be a large-screen television or another display device, and the video stream distribution device can register the signature with a content distribution system. When the display device renders the video content, the audio signature is broadcast and can be detected by a user's mobile device, provided the user has actively requested that the mobile device detect the audio signature. For example, the video content can include a graphic or audio segment that indicates that there is an audio signature that can be captured by a user device to obtain supplemental content related to the video content, e.g., if the user device opens an application to capture the audio signature. In response for this request to detect the audio signature to request supplemental content related to the displayed video content, the user's device can transmit the audio signature to the content distribution system, and the content distribution system can supplemental content related to the displayed video content.

Further to the descriptions throughout this document, a user may be provided with controls (e.g., user interface elements with which a user can interact) allowing the user to make an election as to both if and when systems, programs, or features described herein may enable collection of user information (e.g., information about a user's social network, social actions, or activities, profession, a user's preferences, or a user's current location), and whether the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

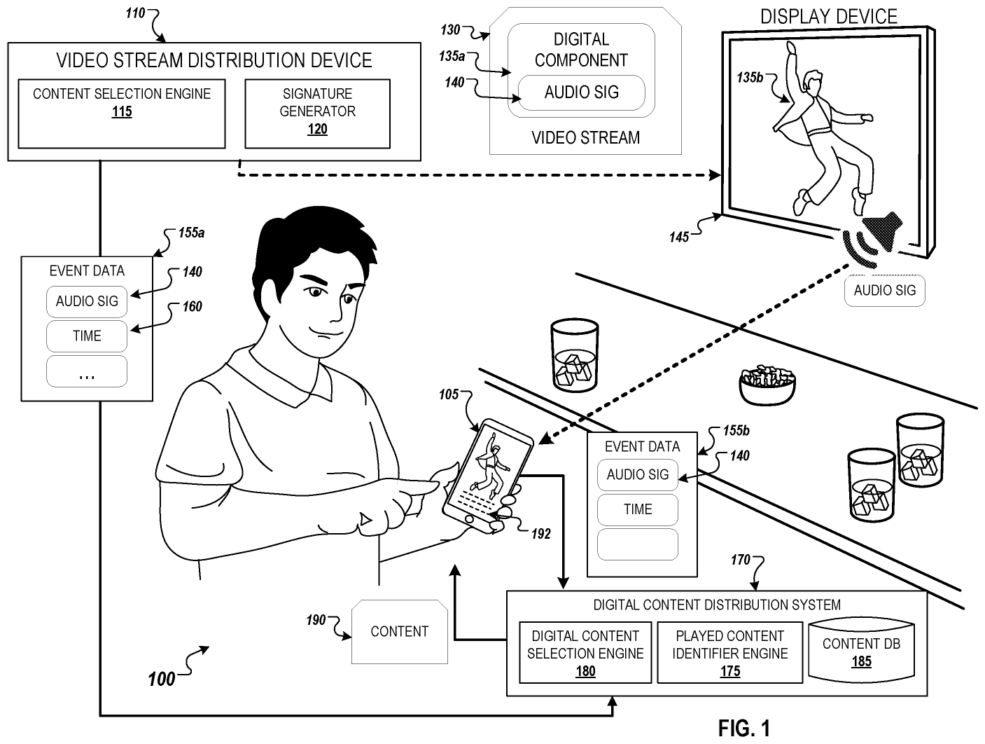

FIG. 1 shows an example of an environment 100 for adaptive content distribution using audio signatures having encoded identifiers. The environment 100 includes one or more client devices 105, a video stream distribution device 110, one or more display devices 145 and a digital content distribution system 170.

A client device 105 is an electronic device that is capable of requesting and receiving resources over a network such as the Internet or an intranet. Example client devices 105 include personal computers, mobile communication devices, wearable devices, personal digital assistants, and other devices that can send and receive data over the network. A client device 105 typically includes user applications, such as a web browser, to display information, permit user interactions (e.g., taps, swipes, typing, etc.), and facilitate the sending and receiving of data over the network. Native applications executed by the client device 105 can also facilitate such functions. Client devices 105, and in particular personal digital assistants, can include hardware and/or software that enable voice interaction with the client devices 105. For example, the client device 105 can include a microphone through which users can submit audio (e.g., voice) input, such as commands, search queries, browsing instructions, smart home instructions, and/or other information. When explicitly authorized by the user of the client device 105, such microphones can also detect other sounds in the environment around the client device 105. Additionally, the client devices 105 can include speakers through which users can be provided audio (e.g., music, voice, etc.) output. A personal digital assistant can be implemented in any client device 105, with examples including wearables, a smart speaker, home appliances, cars, tablet devices, or other client devices 105. Client devices 105 can also include video streaming devices and gaming devices, e.g., gaming consoles.

A video stream distribution device 110 can provide video streams 130 (or other forms of video content) to display devices 145 and provide event data 155 to the digital content distribution system 170. The video stream distribution device 110 can transmit video streams 130 over any suitable network, which can include the Internet, a satellite network, a dedicated cable network, among other examples. The video stream distribution device 170 can include a content selection engine 115 and a signature generator 120.

A video stream 130 can include audio, video or multimedia data, and can be encoded in any appropriate video streaming format. For example, a video stream 130 can be encoded as a Moving Picture Expert Group-4 (MP-4), Advanced Video Coding (AVC), Audio Video Interleaved (AVI), etc. Each such format can encode video and audio data. A video stream 130 can further include an audio signature 140 that is encoded in the audio data of the video stream 130. When the video stream 130 is played by the display device 145, the display device 145 can play the audio signature 140 through a speaker of the display device 145 (e.g., a built-in speaker or speaker connected to the display device 145 wirelessly or via wires) such that the audio signature 140 can be detected by microphones.

An audio signature 140 can be an identifier encoded as audio data, and can be included in a video stream 130 such that the audio signature is undetectable, or very difficult to detect, by a human. For example, the audio signature 140 can be inserted into the video stream 130 using parity coding, phase coding, spread spectrum, echo hiding or other appropriate techniques. The audio signature 140 can be decoded into an identifier associated with the video stream 130 or with a particular transmission of the video stream 130. For example, each individual transmission of a video stream 130, such as a particular episode of a television program, and/or each individual transmission of an individual unit of video content of the video stream 130 can include a unique audio signature 140. Since the audio signature has no inherent meaning (e.g., it can be a sequential index, a random bit string, etc.), the audio signature is private as it cannot be decoded by other systems. The audio signature 140 can be included a single time in the video stream 130 or it can be included repeatedly within the video stream 130. For example, the audio signature 140 can be repeated throughout the video to provide many opportunities for a user to capture the audio signature using the client device 105.

In some implementations, the audio signature 140 can be determined based on the audio associated with a video stream 130. For example, an audio signature 140 can be a hash function applied to the audio portion of a video stream 130 at a particular offset into the video stream 130 (e.g., 2 seconds into the video stream 130).

As used throughout this document, the phrase “digital component” refers to a unit of digital content or digital information, e.g., a video clip, audio clip, multimedia clip, image, text, or another unit of content, and a digital component can include other digital components. For example, a digital component that is a video clip can include a shorter snippet of video that itself is a digital component. While FIG. 1 illustrates digital components 135a, 135b (collectively referred to as digital component 135) as being a component of a video stream 130, in various implementations, a video stream 130 can be a digital component 135, a digital component 135 can be a component of a video stream 130 and a digital component 135 can include a video stream 130. For example, a video stream 130, which is a digital component 135, can be a live video of a sporting event. During breaks in play, video digital components can be displayed to the viewers of the sporting event. For example, information about a player participating in the sporting event can be shown during a break. In another example, information about sports equipment can be shown during a break. In addition, once the video stream 130 ends, a digital component 135 can be transmitted and displayed. For example, that digital component 135 might contain highlights from the live sporting event. Each digital component and/or each individual display of a digital component can have a unique identifier that can be encoded in an audio signature and played during the display of the digital component, e.g., repetitively as described above.

A digital component 135 can electronically be stored in a physical memory device as a single file or in a collection of files, and digital components can take the form of video files, audio files, multimedia files, image files, or text files and include advertising information, such that an advertisement is a type of digital component. For example, the digital component 135 may be content that is intended to supplement content of a video stream 130 or of a web page, resource, or application page presented on a display (e.g., a display device 145 or the display of a client device 105). More specifically, the digital component 135 may include digital content that is relevant to the resource content (e.g., the digital component may relate to the same topic as web page content, or to a related topic). The digital component 135 can further include metadata that is not displayed, but which describes the digital component. Such metadata can include the author of the digital component, the category of a digital component 135 (e.g., automobiles, soccer, travel, etc.), the format of the digital component, among many other examples. The provision of digital components 135 can thus supplement, and generally enhance, other content.

The content selection engine 110 of the video stream distribution device 110 is configured to accept requests for content (e.g., from a display device 145) and provide video streams 130 according to the requests. The requests for content can be requests for particular programs (e.g., a live soccer match), for a content channel (e.g., a broadcast network), for a category of content (e.g., a movie featuring an actor), or for other content types.

A signature generator 120 is configured to generate audio signatures 140 for inclusion in video streams 130. As described above, in some implementations, the signature generator 120 can create an audio signature 140 associated with a particular video stream 130 (e.g., an episode of a television program). In some implementations, the signature generator 120 can create an audio signature 140 associated with a particular instance of video stream 130 (e.g., a particular transmission of the episode of the television program). In some implementations, some or all video streams 130 include audio signatures 140 when they are provided to the video stream distribution device 110, and the signature generator need not generate signatures in such cases.

In addition, the signature generator 120 can generate audio signatures for each digital component 135 displayed with the video stream 130, e.g., during breaks in the primary content of the video stream 130 and/or displayed after the video stream 130 completes, such as content, e.g., highlights, that are related to the video stream 130 . . . . The audio signature for each digital component can include a unique identifier for the digital component or a unique identifier for the individual display of the digital component within this video stream 130. As there can be billions of digital components displayed each day, encoding a unique identifier for each individual display of a digital component can require more data to be encoded in the audio signatures, e.g., to have a unique identifier for each of the billions of displays. Using the same identifier and/or audio signature for each display of a digital component reduces the amount of data encoded in the audio signatures and the processing power and general resources required to create those audio signatures. However, to identify which unique display of the digital component was captured by a client device 105 can involve some correlation using additional information, as described below.

Upon transmission of a video stream 130 to a display device 145, the video stream distribution device 110 can provide event data 155 to the digital content distribution system 170. Event data 155 can include an identifier associated with the audio signature 140 included in the video stream 130 and metadata describing the event and the display device 145. For example, metadata can include the time 160 at which the video stream 130 was transmitted and/or displayed by the display device 145 (which may be the same), an indication of the request that resulted in the transmission, the request submitter, the submitter's location, an identifier of the display device 145, the location of the display device 145, properties of the computing environment (e.g., the network speed between the video distribution device 110 and the display device 145), among other examples. In a particular example, the event data 155 for a video stream 130 can include a tuple of data that includes the identifier of the video stream 130 and the time at which the video stream 130 was displayed. In another example, the event data 155 for a video stream 130 can include a tuple of data that includes the identifier of the video stream 130, the time at which the video stream 130 was displayed, and the location of the display device 145. The location information can be a geographic location (e.g., city, state, province, etc.) or a particular building or facility (e.g., a particular airport, restaurant, theater, etc.).

For video streams 130 that have multiple audio signatures, e.g., a video of a sporting event with digital components, the video stream distribution device 110 can generate and provide audio signatures for the primary content (e.g., the sporting event) of the video stream 130 and one or more of the digital components displayed with the primary content. In addition, the video stream distribution device 110 can provide event data 155 for the primary content and event data 155 for each displayed digital component that has an audio signature. The event data 155 for each piece of content can include the time at which that piece of content was displayed. In some implementations, upon displaying a video stream 130, the display device 145 can provide to the video stream distribution device 110 and/or the digital content distribution system 170 an indication of the time at which the video stream 130 was displayed, the time at which a digital component 135 was displayed, or both.

Some implementations can include a component repository that includes information descriptive of the digital components 135 that can be, and/or have been, displayed on the display device 145 and the audio signature(s) 140 that have been associated with the digital component. Such descriptive information can also include any data relevant to the digital component 135. For example, the descriptive information can include a unique identifier for the digital component, a list of objects (cars, people, cats, etc.) shown in the digital component, a version of the digital component, colors included in the digital component, data describing any sounds, among other examples. When the video stream distribution device 110 provides a video stream 130 including an audio signature 140 and a digital component 135 to a display device 145, the video stream distribution device 110 can associate the audio signature 140 with the digital component 135 in the component repository. For example, the component repository can be a relational database, and the video stream distribution device 110 can create a record in the component repository that contains the audio signature 140 and the digital component 135.

The display devices 145 can be any device, including network-connected devices, capable of receiving and displaying video streams 130. Examples can include Internet-connected televisions, Internet-connected video streaming devices coupled to a television or similar display device, televisions connected to a cable or satellite network, and so on. Upon receipt of the video stream 130, the display device 145 can render the content, including playing the audio and audio signature 140. (As described above, the audio signature 140 can be included a single time in the video stream 130, or it can be repeated within the video stream 130.)

When requested or otherwise actively authorized by a user, the client device 105 can detect the audio signature 140 and transmit event data 155 to the digital content distribution system 170. The user can authorize audio capture using various techniques. For example, the client device 105 can include an application that is configured to capture audio signatures 140, and the application can require that the device owner grant audio capture permissions before capturing audio, e.g., before each time that the application captures audio. In another example, the client device 105 can include an operating system, and the operating system can require that the device owner explicitly consent to audio capture. Further, in some implementations, both the operating system and an application can require consent before audio is captured.

The event data 155 can include the data as described above, and can also include information describing the client device 105, information about the video stream 130 and/or digital component 135, and information related to the detection of the audio signature. For example, information about the client device 105 can include the type of user device (mobile phone, tablet, laptop, etc.), properties of the client device 105 (e.g., display type, display resolution, processor type, processor speed, etc.), and so on. Information about the detection can include the time of detection, the geographic location of the detection (which can be the same type of location information described above for the event data 155 received from the video stream distribution device 110), the number of times the audio signature 140 was detected, and so on. The event data 155 can also include other appropriate descriptive data.

The digital content distribution system 170 is configured to receive event data 155 from the client device 105 and provide content 190 to the client device 105 and/or to other client devices, such as other client devices associated with the user of the client device 105. The digital content distribution system 170 can include a played content identifier engine 175, a digital content selection engine 180, and a content database 185.

The played content identifier engine 175 can accept event data 155 that includes an audio signature 140 and determines the information (video stream 130 and/or digital component 135) that was displayed by the display device 145. In some implementations, the played content identifier engine 175 can compare the audio signature 140 to audio signatures received from the video stream distribution service 110 to determine the information displayed. In some implementations, the played content identifier engine 175 includes an audio signature decoder that accepts audio (e.g., the audio included in the video stream 130), and determines the audio signature 140 from the audio.

The digital content selection engine 180 is configured to receive a content request and respond to the content request with appropriate content. For example, the content request can include event data 155 that includes a captured audio signature 140, and/or data representing a captured audio signature 140, along with a request for supplemental content related to the video content identified by the identifier encoded into the audio signature 140. A content request can also include event data 155. The content request can further include information about the video stream 130 or the display of the video stream 130, such as a timestamp that indicates when the audio signature 140 included in the event data 155 was captured.

The digital content selection engine 180 can determine that the content request is requesting content related to the video stream 130, which can include the digital component 135, as described further below. In response, the digital content selection engine 180 can select content 190 from a content database 185, and the digital content distribution system 170 can transmit the content 190 to the client device 105. In some implementations, the digital content distribution system 170 can transmit the content 190 to other client devices, such as another client device associated with the user, in addition to, or instead of, transmitting the content 190 to the client device 105 that detected the audio signature 140. For example, if a user has registered multiple devices to receive content (e.g., a mobile phone and a tablet), the digital content distribution system 170 can transmit the content 190 to all registered devices. The content 190 can include information 192 that supplements content in the video stream 130. For example, if the video stream 130 depicts a concert, the content 190 can include information about the artist, a tour schedule, a link to artist-related merchandise, and so on.

The content database 185 can be any storage platform configured to store content. For example, the content database 185 can be a relational database or an unstructured database. Further, while the content database 185 is illustrated as a single data store, the content database 185 can be any collection of storage systems, including storage systems that are geographically distributed.

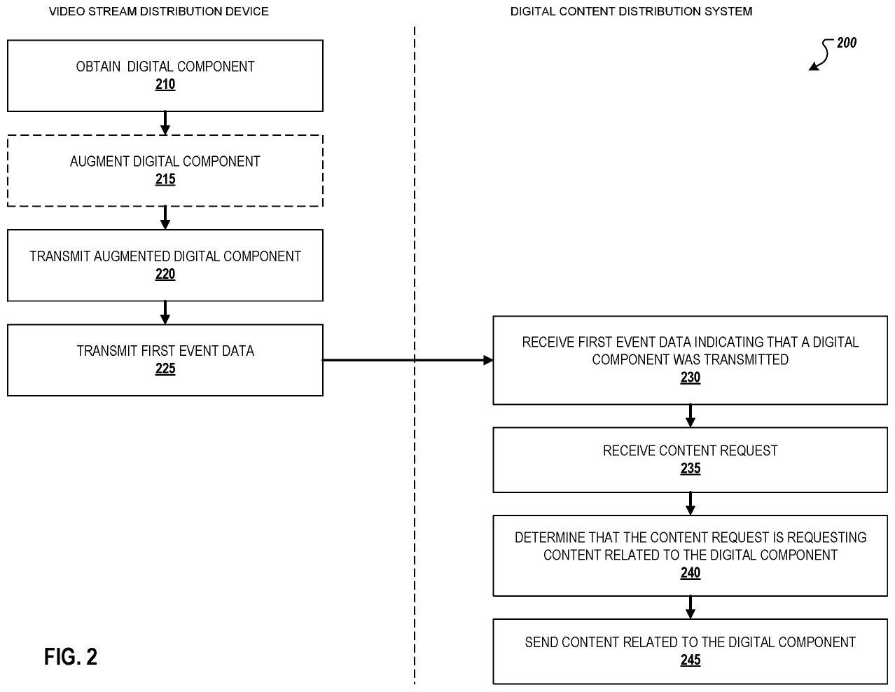

FIG. 2 is a flow diagram of an example process 200 for adaptive content distribution using audio signatures having encoded identifiers. For convenience, the process 200 will be described as being performed by a video stream distribution device and a digital content distribution system, e.g., the video stream distribution device 110 and the digital content distribution system 170 of FIG. 1, appropriately programmed to perform the process. Operations of the process 200 can also be implemented as instructions stored on one or more computer readable media, which may be non-transitory, and execution of the instructions by one or more data processing apparatus can cause the one or more data processing apparatus to perform the operations of the process 200. One or more other components described herein can perform the operations of the process 200.

The video stream distribution device obtains (210) a digital component for distribution to one or more display devices. As described above, the digital component can be included in a video stream or the digital component can be a video stream. In some implementations, the video stream distribution device can separately obtain a digital component and a video stream, and can embed the digital component in the video stream. For example, the video stream can include an indicator of a location within the video stream (e.g., a time in the video stream at which the digital component should be inserted), and the video stream distribution device can insert the digital component in the video stream at that corresponding location using any appropriate video editing technique.

The video stream distribution device can obtain the digital component from any digital component provider using any appropriate data transmission mechanism. For example, the video stream distribution device can provide an application programming interface (API), which, when called by a digital component provider, enables the digital component provider to transmit the digital component to the video stream distribution device. In another example, the video stream distribution device can receive a digital component that is transmitted over a network using HyperText Transfer Protocol (HTTP), HTTP-Secure (HTTPS), Transmission Control Protocol/Internet Protocol (TCP/IP), and so on. In some implementations, the video stream distribution device includes a repository of digital components, and can obtain a digital component from the repository.

In some implementations, the video stream distribution device augments (215) the digital component by inserting an audio signature. The video stream distribution device can insert the audio signature into the digital component prior to inserting the digital component into a video stream sent from the video stream distribution device to the given display device. For example, the video stream distribution device can generate and/or insert the audio signature into the digital component at request time, e.g., between a time at which a request for a video stream or the digital component is received and a time at which the digital component is provided to a display device for display. In this way, the video stream distribution device can dynamically assign an identifier to the unique display of the digital component (or obtain this identifier from another device or system, e.g., the digital content distribution system) and encode the identifier in the audio signature. This allows the video stream distribution device to insert other dynamic information into the audio signature as well, e.g., a device identifier for the display device receiving the digital component, the time at which the digital component is being transmitted or displayed by the display device, and/or other appropriate data.

The video stream distribution device can use any appropriate mechanism for inserting the audio signature into the digital component. For example, the audio signature can be blended into the audio associated with the digital component using any appropriate audio mixing technique. As described above, examples of encodings can include parity coding, phase coding, spread spectrum and echo hiding, among other examples.

In some implementations, the digital component includes a video snippet and the video stream distribution device inserts the audio signature into the digital component such that the audio signature repeats multiple times while the video snippet is played by the display device. For example, the video stream distribution device can include the audio signatures at multiple locations within the digital component, e.g., at regular intervals such as every 0.5 second, 1 second, 2 seconds, etc. In another example, the video stream distribution device can include in the video snippet an indication that the audio signatures is to be played at a given interval. This enables a user to capture the audio signature any time while the digital component is being displayed.

In some implementations, the digital component can include the audio signature when it is received by the video stream distribution device. In such cases, the video stream distribution device need not insert the audio signature, as the audio signature is already present, although the video stream distribution device can insert additional audio signatures.

The video stream distribution device transmits (220) the augmented digital component to one or more display devices using any appropriate transmission protocol. For example, the video stream distribution device can transmit the augmented digital component using HTTP Live Streaming (HLS), Dynamic Adaptive Streaming over HTTP, Real-Time Messaging Protocol (RTMP), Real-Time Streaming Protocol (RTSP), and so on. The video stream distribution device can further store the time at which the digital component was transmitted. As described above, the video stream distribution device can also provide the audio signature and an indication of the digital component to a component repository.

The video stream distribution device can create and transmit (225) the first event data to the digital content distribution system. As described above, the first event data can include a timestamp that indicates the time at which the digital component was transmitted and/or displayed and an indication of the audio signature. The indication can be the encoded audio itself, the data encoded by the audio signature, such as an index value that is unique to the digital component or to the transmission of the digital component, or other indications of the audio signature. For example, the video stream distribution device can store audio signatures in a repository and include a reference to the audio signature (e.g., a reference can be a unique key). The video stream distribution device can include as an indication of the audio signature the reference to the audio signature stored in the repository.

In some implementations, the digital content distribution system can include an indexed repository containing audio signatures and associated digital components. When the digital component distribution receives an audio signature, the digital content distribution system can determine the digital component by using the audio signature as an index to retrieve the digital component from the indexed repository.

The digital content distribution system receives (230) from the video stream distribution device the event data indicating that a digital component, which includes an audio signature among other data, was transmitted to a display device. As described above, the event data can include an identifier encoded in the audio signature and an indication of the time at which the digital component was transmitted to the given display device. The digital content distribution system can retain the event data, e.g., by storing the event data in a repository.

The digital content distribution system can receive the event data using any appropriate technique. For example, the digital content distribution system can include an API that, when called by the video stream distribution device, enables the digital content distribution system to receive the first event data. In another example, the digital content distribution system can receive the event data over a networking protocol such as TCP/IP, HTTP or HTTP-S.

The digital content distribution system receives (235), from a client device that is different from the display device, a content request that includes event data, and the event data can include data representative of a captured audio signature and a time at which the captured audio signature was captured. For example, a user who is viewing a video stream on a display device can interact with an application on a mobile device to indicate interest in the digital component, and in response, the mobile device can send the content request. The data representative of the captured audio signature can include the audio signature and/or an identifier decoded from the captured audio signature, as described above.

In some implementations, in response to receiving the content request, the digital content distribution system can update one or more performance metrics for the digital component. The digital content distribution system can use the audio signature to determine that the content request is relevant to a particular digital component (e.g., a digital component included in a video stream), and adjust performance metrics. For example, the digital content distribution system can increment the number of times content was requested for the digital component or the number of times content was requested within a period of interest. In another example, the client device can provide its geographic location, or approximate geographic location, and the digital content distribution system can increment the number of times content was requested for the digital component from that geographic region.

In some implementations, the digital content distribution system can update performance metrics related to the content transmitted to the display device or to the content that is provided in response to the content request, as described further below. For example, the digital content distribution system can update performance metrics related to any content displayed on the display device or on the client device before or after the digital component is displayed. The performance metrics can be updated (i) in response to receiving the content request, (ii) in response to determining that the content request relates to the displayed digital component, (iii) in response to determining that the content request relates to a different component that was displayed before or after the displayed digital component, and/or (iv) based on other determinations. In some circumstances, users might be more likely to request content related to a displayed digital component if the display of the digital component follows the display of a sequence of other digital components, if the digital component is embedded in a particular video stream or type of video stream, if a sequence of video streams has been displayed, and so on. To determine correlations among displayed digital components, the system can store all information, or any subset of the information, related to the display of digital components, including the sequence in which they are shown, the video streams containing the digital components, the number of request for content related to a digital component, characteristics of the requests (e.g., the location from which requests originate), and so on. The system can determine, from the stored information, sequences of content that are more likely to result in user engagement. The system can use any appropriate correlation technique or any appropriate machine learning model to determine such patterns of engagement. The determination can be based, in any combination, on audio identifiers, on audio identifiers broadcast within a particular period of time, on the location at which the audio identifier was broadcast. In some implementations, these operations can be performed by another component in the system (e.g., a component configured to maintain performance metrics) in addition to, or instead of, being performed by the digital content distribution system.

In some implementations, the digital content distribution system can store event data, and use the event data to determine preferred digital components and preferred video streams. The digital content distribution system can determine features of the event data provided by the client device, such as the geography of the content request (e.g., location of client device that sends the request), the type of content requested (text, multimedia, application to install, etc.) and information describing the content requested. The system can then use such features to create an input for one or more trained machine learning models configured to predict video streams of interest and/or content of interest. Additional features can also be included in the input. The trained machine learning model can process the input to produce predicted video streams of interest and/or content of interest. Predictions regarding video streams of interest can be transmitted to the video stream distribution device to enable the video stream distribution device to select video streams for future distribution to display devices. Predictions regarding content of interest can be used as a factor in determining content to provide to client devices.

The digital content distribution system determines (240) that the content request is requesting content related to the digital component based at least on (i) a determination that the audio signature matches the audio signature of the digital component and (ii) a determination that the time at which the content request is received is within a threshold duration of the time at which the corresponding event data was received from the video stream distribution device. As described above, the digital content distribution system can receive an audio signature from the video stream distribution device, and can receive an audio signature that is included in a content request. The digital content distribution system can compare the audio signature included in the content request to the audio signature received in event data from the video stream distribution device to determine whether any audio signatures match. If such a match exists, the digital content distribution system can compare the time the content request was received to the time contained in the event data to determine whether the times are within a configured threshold. The configured threshold can be any appropriate duration, such as five second, ten seconds, one minute, etc.

The digital content distribution system can use the time information to correlate the audio signature captured by the client device with the particular display of the digital component that included the audio signature. For example, different versions of the digital component can be displayed in different locations and/or at different times and each version of the digital component can have the same identifier and audio signature. Using the time information enables the digital content distribution system to determine which particular version was displayed. In addition, different supplemental content can be provided based on the version that was displayed and/or based on other contextual information corresponding to the displayed digital component (e.g., time and/or location). Being able to correlate particular displays of the digital component with what is captured by a user enables dynamic selection of supplemental content to provide in response to a request.

The time and/or location information also enables the digital content distribution system to determine which digital components were shown before and/or after the digital component for which the user captured the audio signature. Each display device can display different digital components that other display devices showing the same video stream. For example, in video streaming, the video stream distribution device can interact with the digital content distribution system to request digital components for display at a display device based on contextual signals, e.g., the geographic location of the display device, the type of building or facility at which the display device is located, the time of day when the digital component will be displayed, etc. Thus, a sequence of digital components displayed during the same video stream, e.g., of a sporting event, can vary from display device to display device. Thus, having the time and/or location information, or the device identifier for the display device enables the digital content distribution system to identify a sequence of digital components shown at the display device.

In response to determining that the content request is requesting content related to the digital component, the digital content distribution system sends (245) the content related to the digital component to the client device for display by the client device. The digital content distribution system can determine which content is related to the digital component using various techniques. For example, the digital content distribution system can be configured to provide a particular piece of content in response to each individual audio signature—i.e., for each individual audio signature there is a configured piece of content that is provided. In another example, the digital content distribution system can use characteristics of the displayed digital component to characteristics of the available content, and select content that best matches the characteristics. If the user of the client device has opted in to providing preferences or characteristics of the user, the digital content distribution system can use such information to select content.

The digital content distribution system can further consider characteristics of the client device, provided the user of the client device has opted in to providing such characteristics. For example, the digital content distribution system can select a version of the digital component formatted for display by the client device, such as a lower resolution version for a device with a smaller screen, and a higher resolution version for a device with a larger screen.

In some implementations, the event data received from the video stream distribution device can include the geographic location of the display device and/or the event data received from the client device can include the geographic location of the client device. The digital component distribution engine can use either of both geographic locations to determine content with which to respond. For example, if the geographic location of the given display device is within a threshold distance of the geographic location of the client device, the digital component distribution engine can respond with content associated with that geographic location. In some circumstances, a user can be in an environment with multiple display devices (e.g., a restaurant with multiple televisions), and the system can use the geographic location of the user to determine which display device was nearest the user, and therefore, which digital component was viewed, and which digital components are likely to have been viewed previously and after the digital component.

In some implementations, in response to determining that the content request is requesting content related to the digital component, the digital content distribution system can send content related to the digital component before and/or after the digital component is displayed on a display device. To enable sending content before the digital component is displayed on a display device, a user can register interest with the digital content distribution system in a type of digital component (e.g., automobiles, a model of automobiles, a sport, a sports team, etc.), e.g., by transmitting such information using an API provided by the digital component distribution system. When the digital content distribution system receives event data indicating that a digital component was transmitted, the digital content distribution system can provide content relevant to the digital component. For example, the digital content distribution system can select content relevant to the type of digital component transmitted to the display device.

In some implementations, the digital content distribution system can determine a sequence of digital components that have been transmitted to each display device. For example, the digital content distribution system can determine a set of digital components transmitted to the display device based on the event data received from the video stream distribution device and event data received from the client device. The digital content distribution system can use the audio signature included in the first event data to query the component repository and receive an indication of the digital component displayed, and the list of audio signatures that have been associated with the digital component in the component repository. The digital content distribution system can compare the audio signatures with the audio signatures stored from received event data (as described in reference to operation 230) to determine prior occurrences when the digital component was displayed. In addition, the digital content distribution system can use the stored event data to determine the order in which digital components have been displayed on the display device. The digital content distribution system can then consider the order of display of digital content, among other factors, when determining which content to provide to the client device.

Further, a client device can request information about previously displayed digital components by transmitting the audio signatures associated with those digital signatures. For example, a client device can store a configured number of audio signatures (e.g., the most recent 2, 5, 10, etc.) and a user can indicate which audio signature to transmit by interacting with a user interface element (e.g., by clicking or swiping) that displays information about the audio signature, such as when it was displayed.

While this specification has described embedding audio signatures, other embedding techniques are also possible. For example, a visual code can be discreetly embedded in the video, e.g., using steganography, and a client device pointed at a display device can be configured to read the code. In another example, if the display device is configured to emit other signals, e.g., radio frequencies or Bluetooth, and the client device is configured to receive such signals, signatures can be embedded in such signals. In addition, while this specification has described embedding audio signatures in video and multimedia streams, audio signatures can also be embedded in audio-only streams.

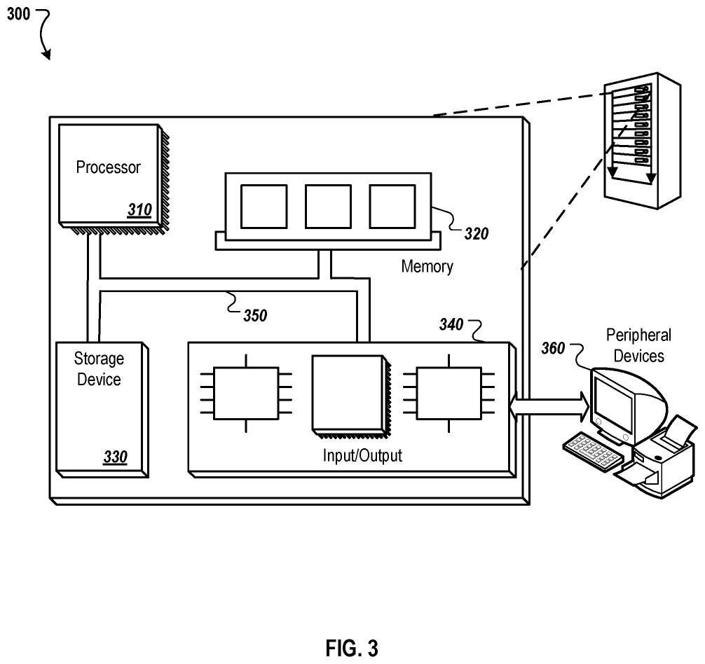

FIG. 3 is a block diagram of an example computer system 300 that can be used to perform operations described above. The system 300 includes a processor 310, a memory 320, a storage device 330, and an input/output device 340. Each of the components 310, 320, 330, and 340 can be interconnected, for example, using a system bus 350. The processor 310 is capable of processing instructions for execution within the system 300. In one implementation, the processor 310 is a single-threaded processor. In another implementation, the processor 310 is a multi-threaded processor. The processor 310 is capable of processing instructions stored in the memory 320 or on the storage device 330.

The memory 320 stores information within the system 300. In one implementation, the memory 320 is a computer-readable medium. In one implementation, the memory 320 is a volatile memory unit. In another implementation, the memory 320 is a non-volatile memory unit.

The storage device 330 is capable of providing mass storage for the system 300. In one implementation, the storage device 330 is a computer-readable medium. In various different implementations, the storage device 330 can include, for example, a hard disk device, an optical disk device, a storage device that is shared over a network by multiple client devices (e.g., a cloud storage device), or some other large capacity storage device.

The input/output device 340 provides input/output operations for the system 300. In one implementation, the input/output device 340 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 360. Other implementations, however, can also be used, such as mobile client devices, mobile communication devices, set-top box television client devices, etc.

Although an example processing system has been described in FIG. 3, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as a hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

To provide for interaction with a user, embodiments of the subject matter described in this specification can be implemented on a client device capable of providing information to a user. The information can be provided to a user in any form of sensory format, including visual, auditory, tactile or a combination thereof. The client device can be coupled to a display device, e.g., an LCD (liquid crystal display) display device, an OLED (organic light emitting diode) display device, another monitor, a head mounted display device, and the like, for displaying information to the user. The client device can be coupled to an input device. The input device can include a touch screen, keyboard and a pointing device, e.g., a mouse or a trackball, by which the user can provide input to the client device. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, unless explicitly stated otherwise, or unless the knowledge of one of ordinary skill in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

1. A method comprising:
receiving, from a video stream distribution device, first event data indicating that a digital component comprising an audio signature was transmitted to a given display device, the event data comprising an identifier encoded in the audio signature and a first time at which the digital component was transmitted to the given display device;
receiving, from a client device different from the given display device, a content request comprising second event data comprising data representative of a captured audio signature and a second time at which the captured audio signature was captured;
determining that the content request is requesting content related to the digital component based at least on (i) a determination that the audio signature matches the audio signature of the digital component and (ii) a determination that the second time is within a threshold duration of the first time; and
in response to determining that the content request is requesting content related to the digital component, sending the content related to the digital component to the client device for display by the client device.

2. The method of claim 1, wherein the content related to the digital component comprises a different version of the digital component formatted for display by the client device.

3. The method of claim 1, wherein the video stream distribution device inserts the audio signature into the digital component prior to inserting the digital component into a video stream sent from the video stream distribution device to the given display device.

4. The method of claim 3, wherein the digital component comprises a video snippet and the video stream distribution device inserts the audio signature into the digital component such that the audio signature repeats multiple times while the video snippet is played by the display device.

5. The method of claim 1, wherein the data representative of the captured audio signature comprises the audio signature or the identifier decoded from the captured audio signature.

6. The method of claim 1, wherein:
the first event data comprises a first location data identifying a geographic location of the given display device and the second event data comprises second location data identifying a geographic location of the client device; and
determining that the content request is requesting content related to the digital component is further based on a determination that the geographic location of the given display device is within a threshold distance of the geographic location of the client device.

7. The method of claim 1, wherein the identifier identifies the digital component or a unique impression of the digital component.

8. The method of claim 1, further comprising, in response to determining that the content request is requesting content related to the digital component, sending content related to one or more first digital components displayed by the given display device prior to display of the digital component and/or one or more second digital components displayed by the given display device after display of the digital component.

9. The method of claim 8, further comprising identifying the one or more first digital components and the one or more second digital components based on the first event data and respective event data for the one or more first and second digital components.

10. The method of claim 1, further comprising updating one or more performance metrics for the digital component in response to determining that the content request is requesting content related to the digital component.

11. The method of claim 1, further comprising updating one or more performance metrics for one or more additional digital components displayed before or after the digital component in response to determining that the content request is requesting content related to the digital component.

12. A system comprising:
one or more processors; and
one or more storage devices storing instructions that, when executed by the one or more processors, cause the one or more processors to perform operations comprising:
receiving, from a video stream distribution device, first event data indicating that a digital component comprising an audio signature was transmitted to a given display device, the event data comprising an identifier encoded in the audio signature and a first time at which the digital component was transmitted to the given display device;
receiving, from a client device different from the given display device, a content request comprising second event data comprising data representative of a captured audio signature and a second time at which the captured audio signature was captured;
determining that the content request is requesting content related to the digital component based at least on (i) a determination that the audio signature matches the audio signature of the digital component and (ii) a determination that the second time is within a threshold duration of the first time; and
in response to determining that the content request is requesting content related to the digital component, sending the content related to the digital component to the client device for display by the client device.

13. (canceled)

14. (canceled)

15. The system of claim 12, wherein the content related to the digital component comprises a different version of the digital component formatted for display by the client device.

16. The system of claim 12, wherein the video stream distribution device inserts the audio signature into the digital component prior to inserting the digital component into a video stream sent from the video stream distribution device to the given display device.

17. The system of claim 16, wherein the digital component comprises a video snippet and the video stream distribution device inserts the audio signature into the digital component such that the audio signature repeats multiple times while the video snippet is played by the display device.

18. The system of claim 12, wherein the data representative of the captured audio signature comprises the audio signature or the identifier decoded from the captured audio signature.

19. The system of claim 12, wherein:
the first event data comprises a first location data identifying a geographic location of the given display device and the second event data comprises second location data identifying a geographic location of the client device; and
determining that the content request is requesting content related to the digital component is further based on a determination that the geographic location of the given display device is within a threshold distance of the geographic location of the client device.

20. The system of claim 12, wherein the identifier identifies the digital component or a unique impression of the digital component.

21. The system of claim 12, wherein the operations comprise, in response to determining that the content request is requesting content related to the digital component, sending content related to one or more first digital components displayed by the given display device prior to display of the digital component and/or one or more second digital components displayed by the given display device after display of the digital component.

22. A non-transitory computer readable medium carrying instructions that, when executed by one or more processors, cause the one or more processors to perform operations comprising:
receiving, from a video stream distribution device, first event data indicating that a digital component comprising an audio signature was transmitted to a given display device, the event data comprising an identifier encoded in the audio signature and a first time at which the digital component was transmitted to the given display device;
receiving, from a client device different from the given display device, a content request comprising second event data comprising data representative of a captured audio signature and a second time at which the captured audio signature was captured;
determining that the content request is requesting content related to the digital component based at least on (i) a determination that the audio signature matches the audio signature of the digital component and (ii) a determination that the second time is within a threshold duration of the first time; and
in response to determining that the content request is requesting content related to the digital component, sending the content related to the digital component to the client device for display by the client device.
